(19) United States
(12) Patent Application Publication
(10) Pub. No.: US 2002/0061015 A1
(43) Pub. Date: May 23, 2002

(54) Matrix switch circuit

(76) Inventor: Tsugio Takahashi, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/849,362

(22) Filed: May 7, 2001

(30) Foreign Application Priority Data
May 11, 2000 (JP) 138478/2000

(51) Int. Cl. H04L 12/56

(52) U.S. Cl. 370/369; 370/386

(57) ABSTRACT

In an embodiment of a matrix switch circuit, a group provided with twelve 64-to-1 selectors is arranged by 64 pieces, that is, (12×64) pieces of 64-to-1 selectors are provided. Address information is input to the selector. STS-12 (one frame) in which twelve 8-bit STS-1 (unit data) are serially arrayed is input from 64 pieces of input terminals of the selector. The matrix switch circuit is further provided with a selecting circuit that selects specific unit data in the frame and 64 pieces of 12-to-1 selectors that forms unit data output from the selecting circuit in one frame and outputs it.

### BACKGROUND OF THE INVENTION

1. Field of the Invention

The present invention relates to a matrix switch circuit used in an optical cross connection system, particularly relates to a matrix switch circuit effective for a large-scale network.

2. Description of the Related Prior Art

An optical cross connection system has configuration that plural communication stations are connected via two pairs of optical fiber rings for example. As shown in FIG. 1 as an example, first to fourth stations 101 to 104 are connected via two optical fibers 105 and 106. Further, the fourth station 104 is connected to another optical fibers 109 and 110. A signal is transmitted counterclockwise in the optical fiber 105 and is transmitted clockwise in the optical fiber 106. The first station 101 is provided with a cross connector 121 that sets a detour path and a switching system 123 that connects to a subscriber's set 122. The other stations also have the same configuration. When an optical fiber 114 between the first and second stations is disconnected, the cross connector 121 normally sets a detour path using the optical fiber 105. The cross connector 121 also normally connects a desired combination out of plural inputs and plural outputs. FIG. 2 shows a concrete example of the cross connector 121. The cross connector 121 is provided with a matrix switch 147 formed by digital LSI (matrix switch LSI), the preceding signal processing section 143 and the succeeding signal processing section 153. Each preceding signal processing section 143 is connected to any of optical fibers 131-1 to 131-3 having the capacity of 10 Gbps or any of optical fibers 131-4 to 131-7 having the capacity of 2.5 Gbps. Each succeeding signal processing section 153 is also connected to any of optical fibers 132-1 to 132-3 having the capacity of 10 Gbps or any of optical fibers 132-4 to 132-7 having the capacity of 2.5 Gbps. The preceding signal processing section 143 is provided with a photoelectric converter 141 and a terminating set 142. The succeeding signal processing section 153 is provided with a converter connected to the matrix switch 147 and an electrooptic converter 152. The terminating set in the preceding signal processing section connected to the optical fiber having the capacity of 10 Gbps executes the terminating processing of a synchronous transfer signal (STS) -192, converts and outputs an input signal to 16 sets of STS-12. The terminating set in the preceding signal processing section connected to the optical fiber having the capacity of 2.5 Gbps executes the terminating processing of STS-192, converts and outputs an input signal to four sets of STS-12. Therefore, the matrix switch 147 processes the data of 40 Gbps. In case the minimum unit of a signal switched by the matrix switch 147 is STS-1 of 52 Mbps, 10 Gbps is equivalent to 192 pieces of STS-1. Therefore, the matrix switch that processes the data of 40 Gbps is required to process 768 pieces of STS-1. That is, the switch formed by matrix switch LSI is a 768×768 matrix switch having 768 inputs and 768 outputs. Such LSI that processes a large number of signals has problems such as the difficulty of the layout and the increase of power consumption.

For switch architecture for realizing large-scale switching, the following circuit is known for example. FIG. 3 shows a crosspoint switch circuit disclosed in Japanese published unexamined patent application No. Hei 8-65719. This circuit is provided with four input terminals 162, four output terminals 163, a switch decoder 164 and an address buffer 165. The switch decoder 164 is provided with four units 166 and four switches. The address buffer 165 is provided with four units 167. A binary initial address message 168 is supplied from the unit 167 to the unit 166 and the switch. In each unit 166, a MOS transistor 171 having functions as a switch and a decoder is turned on or off according to the initial address message and selects any of the input terminals 162. As the scale of the circuit shown in FIG. 3 is small, a large-scale switch is required to be configured by multistage connection. However, as this circuit uses a transfer gate, the high-speed operation is difficult because the load capacity is increased due to multistage connection. FIG. 4 shows another matrix switch circuit 181. In this circuit, a 768-to-1 selector is formed by a general CMOS gate circuit. This circuit is provided with 64 pieces of 1-to-12 serial-parallel conversion circuits 183. Each conversion circuit receives the data of 622 Mbps and converts these to parallel data 184 including 768 pieces of unit data by 52 Mbps. The parallel data 184 is input to the 768-to-1 selector 185, the selector 185 makes the input side and the output side correspond according to a selection signal 186 and converts the parallel data 184 to parallel data 187 including 768 pieces of unit data. Afterward, the data is converted reversely to the above-mentioned conversion and is output from a 12-to-1parallel-serial conversion circuit 188. As this matrix circuit 181 uses a CMOS gate circuit, the processing speed can be enhanced. However, in this circuit 181, signals distributed to 768 signal conductors are distributed to 768 pieces of 768-to-1 selectors. Therefore, as the very many signal conductors are provided, it is very difficult to design the layout of the circuit. FIG. 5 shows further another matrix switch circuit 190. In this circuit 190, 64 pieces of write data 191 respectively of 622Mbps are input to a memory 192 provided with a selector and 64pieces of read data 193 respectively of 622 Mbps the relation between the input and the output of which is arbitrarily set are output from the memory. A 10-bit write address 194 and a predetermined write clock 195 are input to the memory 192, and a 10-bit read address 196 and a predetermined read clock 197 are input to the memory. However, in this matrix switch circuit 190, as the power consumption of the memory in writing is large and the power consumption of the selector in reading is large, the power consumption of the whole circuit becomes large as a result.

### SUMMARY OF THE INVENTION

Therefore, a first object of the invention is to provide a matrix switch circuit that does not require much power. A second object of the invention is to provide a matrix switch circuit the scale of which is small and the layout of which is easy.

To achieve the objects, the matrix switch circuit according to the invention is provided with total (n×m) pieces of m-to-1selectors to which one frame where n (n: two or more positive integer) pieces of unit data are serially arrayed is input in parallel by m (m: two or more positive integer) pieces, from which predetermined one frame specified in an address is output and which are divided into pieces of groups (one group includes n pieces) . The matrix switch circuit is also provided with (n×m) pieces of selecting circuits that receive the output of the m-to-1 selectors and select specific unit data in one frame specified in an address, mpieces of n-to-1 selectors that receive unit data output from the n pieces of selecting circuits, form and output one frame and a control circuit that sends a control signal to the selecting circuits and the n-to-1 selectors.

In another matrix switch circuit in the invention, input-output data to/from the circuit is p (p: positive integer)-bit parallel data, (p×n×m) pieces of m-to-1 selectors are arranged, (p x m) pieces of n-to-1 selectors are arranged and (p ×m) pieces of input-output lines are arranged.

The matrix switch circuit has input-output lines smaller than those in a conventional type and wiring is easy. The scale and the power consumption of the circuit can be also reduced.

### BRIEF DESCRIPTION OF THE DRAWINGS

The above and other objects, features and advantages of the present invention will become apparent from the following detailed description when taken with the accompanying drawings in which:

FIG. 1 shows a conventional type digital cross connection system;

FIG. 2 shows a conventional type cross connector;

FIG. 3 shows a conventional type crosspoint switch circuit;

FIG. 4 shows a conventional type matrix switch circuit;

FIG. 5 shows a conventional type matrix switch circuit;

FIG. 6 shows a concrete example of an optical cross connection switch system to which the invention is applied;

FIG. 7 is a schematic diagram showing an example of a matrix switch circuit according to the invention;

FIG. 8 is a block diagram showing an example of a first circuit section of the matrix switch circuit according to the invention;

FIG. 9 is a block diagram showing an example of a second circuit section of the matrix switch circuit according to the invention;

FIG. 10 is a schematic diagram showing an example of the matrix switch circuit according to the invention;

FIG. 11 is a time chart showing the operation of an example of the matrix switch circuit according to the invention;

FIG. 12 shows relationship between a format of 622 Mbps (STS-12) and a format of 52 Mbps (STS-1);

FIG. 13 is a block diagram showing another example of an m-to-1 selector;

FIG. 14 is a block diagram showing another example of the m-to-1 selector;

FIG. 15 is a block diagram showing another example of the first circuit section in the matrix switch circuit according to the invention;

FIG. 16 is a time chart showing the operation of an example of the matrix switch circuit using the configuration shown in FIG. 15;

FIG. 17 is a block diagram showing another example of the first circuit section in the matrix switch circuit according to the invention;

FIG. 18 is a block diagram showing another example of the first circuit section in the matrix switch circuit according to the invention;

FIG. 19 is a block diagram showing another example of the first circuit section in the matrix switch circuit according to the invention;

FIG. 20 is a block diagram showing another example of the first circuit section in the matrix switch circuit according to the invention;

FIG. 21 is a block diagram showing an example of the second circuit section in the matrix switch circuit according to the invention;

FIG. 22 shows the circuit scale and the power consumption in case the selector respectively shown in FIGS. 13 and 14 is applied to the matrix switch circuit respectively shown in FIGS. 8 to 10 and in the case of a circuit the scale of which is minimized by the synthesis of logic;

FIG. 23 shows the circuit scale and the power consumption in case the selector respectively shown in FIGS. 13 and 14 is applied to the matrix switch circuit including the first circuit section shown in FIG. 19 and in the case of the circuit the scale of which is minimized by the synthesis of logic; and

FIG. 24 shows the circuit scale and the power consumption in case the selector respectively shown in FIGS. 13 and 14 is applied to the matrix switch circuit including the second circuit section shown in FIG. 21 and in the case of the circuit the scale of which is minimized by the synthesis of logic.

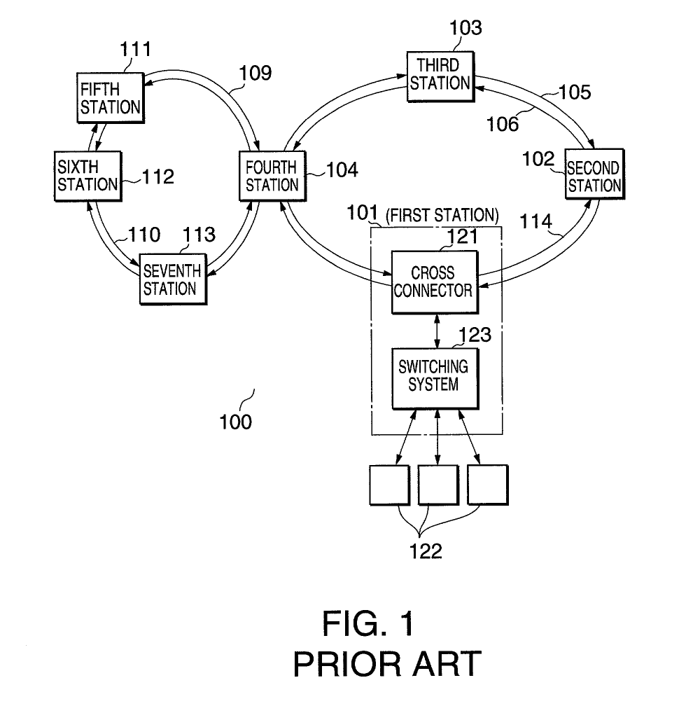

### DETAILED DESCRIPTION OF THE PREFERRED EMBODIMENTS

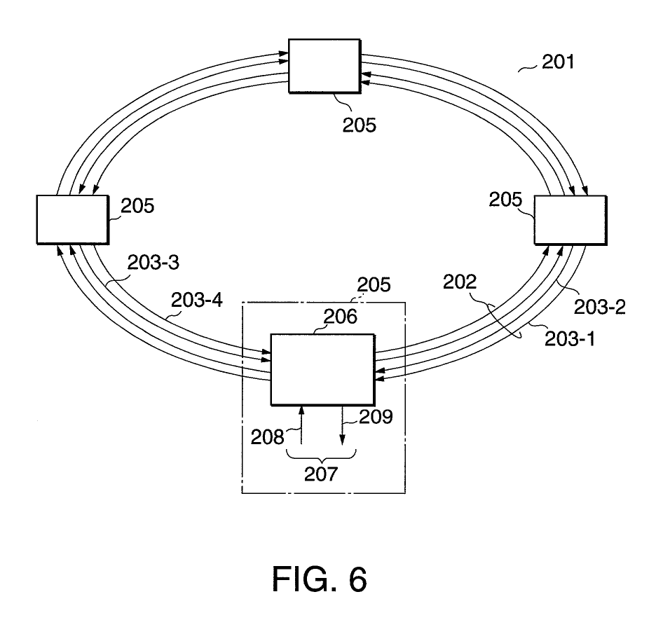

In FIG. 6, an example of an optical cross connection system 201 to which a matrix switch circuit according to the invention is applied is shown. This system 201 is provided with four optical fibers 203-1 to 203-4. A matrix switch circuit 206 in a predetermined communication station 205 arranged on an optical ring 201 is connected to two optical fibers 203-1 and 203-2 in which a signal is transmitted clockwise, two optical fibers 203-3 and 203-4 in which a signal is transmitted counterclockwise and optical fibers 208 and 209 connected to a general subscriber terminal 207. It is supposed that the capacity of data input to the matrix switch circuit 206 is 40 Gbps in total. This circuit 206 switches the input data in units of a synchronous transfer signal (STS) -1 as a data amount in the minimum unit (unit data) . As the data signaling rate of STS-1 is 52 Mbps, the capacity of input data is equivalent to 768 pieces of STS-1 in case the capacity of the input data is 40 Gbps and the capacity of output data is 768 pieces of STS-1 in case the capacity of the output data is 40 Gbps. In the following concrete example, it is supposed that the data signaling rate of an input/output signal is 622 Mbps. Then, in this concrete example, 64 pieces of signals of 622 Mbps (40 Gbps/622 Mbps=64) are included in an input/output signal of 40 Gbps.

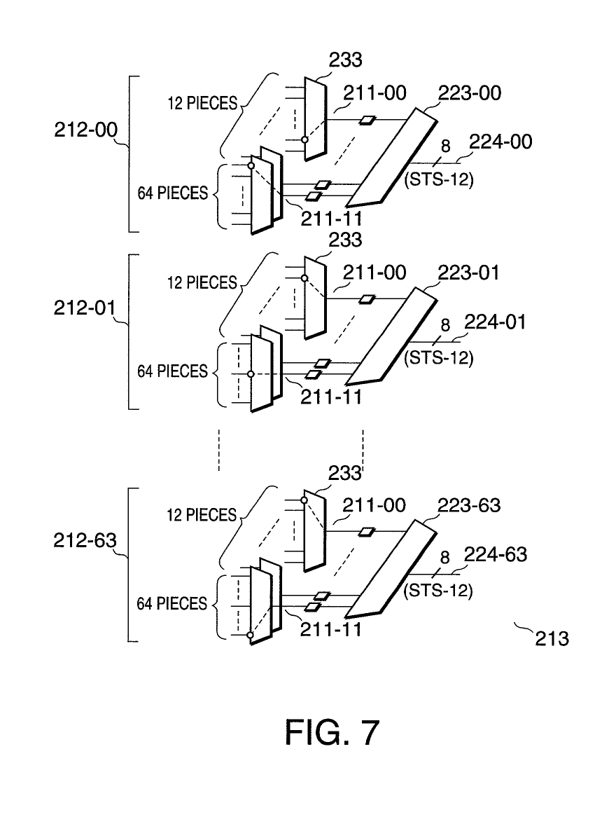

FIG. 7 is a schematic diagram showing an example of a circuit 213 forming the matrix switch circuit 206. The circuit 213 has basic configuration that 64 pieces of second circuit sections 212-00 to 212-63 are arranged in parallel. In each second circuit section 212, twelve first circuit sections 211-00 to 211-11 are arranged in parallel and each first circuit section 211 is provided with a 64-to-1 selector 233. The first circuit section 211 selects one unit data out of 64 pieces of unit data (STS-1). The selected twelve unit data are input to a 12-to-1 selector 223, one unit data is selected according to time series, one frame (STS-12) in which twelve unit data are combined is formed and is output as a frame signal 224. Sixty-four second circuit sections 212 select the (12 ×64) input/output of unit data.

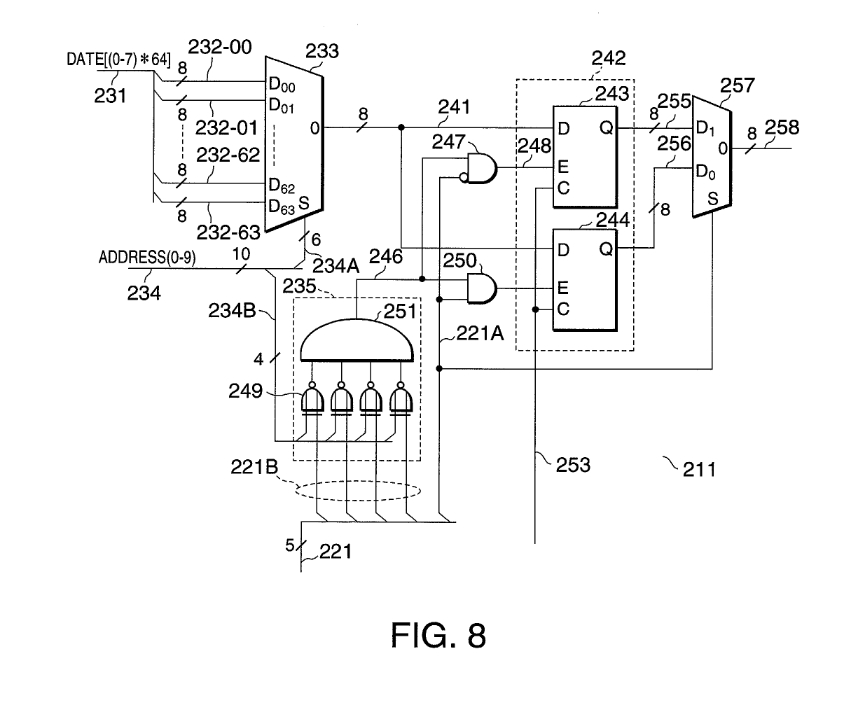

FIG. 8 is a block diagram showing an example of the first circuit section 211. The first circuit section 211 is provided with a 64-to-1 selector 233 to which 64 pieces of 8-bit unit data (STS-1) 232-00 to 232-63 are input in parallel. The eight pieces (for eight bits) of 64-to-1 selectors 233 are arranged. The information 234A of high-order 6 bits of 10-bit address information 234 is input from the selective terminal S to the 64-to-1 selector 233. The information 234B of low-order 4 bits of the address information 234 showing the position of unit data (STS-1) in STS-12 (one frame) is input to an STS-1 selecting circuit 235. An 8-bit parallel signal 241 output from the output terminal 0 of the 64-to-1 selector 233 is input to a data latch flip-flop circuit 242. The data latch flip-flop circuit 242 is provided with a first flip-flop circuit 243 and a second flip-flop circuit 244 respectively arranged in parallel and the signal 241 is input to the data input terminal D of these flip-flop circuits. A signal 248 as a result of AND of a signal 246 output from the STS-1 selecting circuit 235 and a signal acquired by inverting the logic of a selector switching signal 221A is input to an enable terminal E of the first flip-flop circuit 243. A signal as a result of AND of the signal 246 output from the STS-1 selecting circuit 235 and the selector switching signal 221A is input from an AND gate 250 to an enable terminal E of the second flip-flop circuit 244. As each flip-flop circuit 243 and 244 processes 8-bit data in parallel, it includes eight flip-flop circuits (sixteen flip-flop circuits in total). In the STS-1 selecting circuit 235, an exclusive OR circuit 249 outputs each exclusive-OR of the respective bits of the data 221B of low-order four bits output from a 5-bit counter 222 (not shown) and the information 234B of the low-order four bits, an AND gate 251 ANDs respective output and outputs the output signal 246. A clock signal 253 of 78 MHz is input to a clock input terminal C of each flip-flop circuit 243 and 244. In the first flip-flop circuit 243, a signal level at which the selector switching signal 221A is input is inverted. Therefore, in the two flip-flop circuits 243 and 244, when the signal 241 is written to one circuit, writing to the other circuit is prohibited. Latched 8-bit parallel output signals 255 and 256 are respectively output from the output terminal Q of the first and second flip-flop circuits 243 and 244 of the data latch flip-flop circuit 242 and are input to the respective input terminals DO and D1 of a reading switching selector 257. The selector switching signal 221A is input to a selective input terminal S of the reading switching selector 257. An 8-bit output signal 258 is output from an output terminal 0 of the selector 257. Therefore, the 8-bit parallel output signal 258 is output from the circuit to which the 8-bit parallel signal 241 is not written from an input terminal D of the first and second flip-flop circuits 243 and 244. As described above, as data is alternately read/written in the first and second flip-flop circuits 243 and 244, the reliability of operation is enhanced.

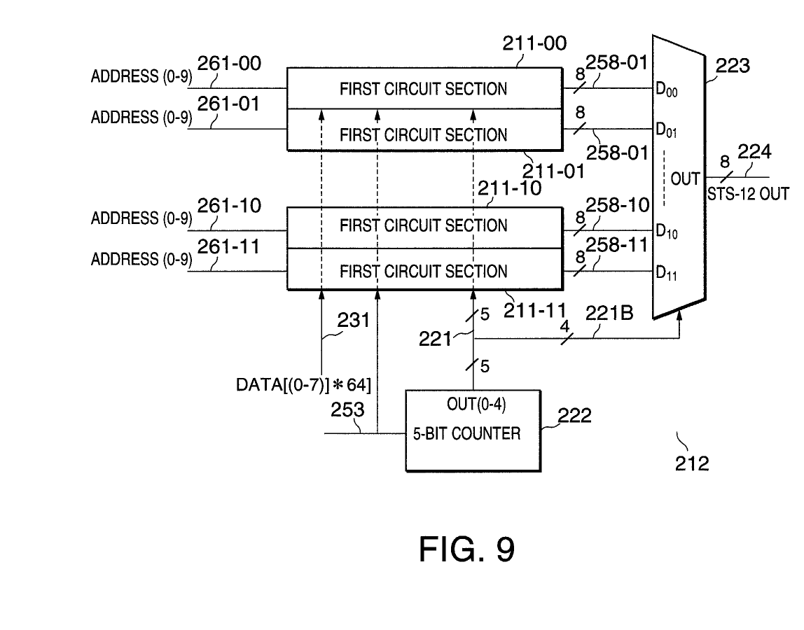

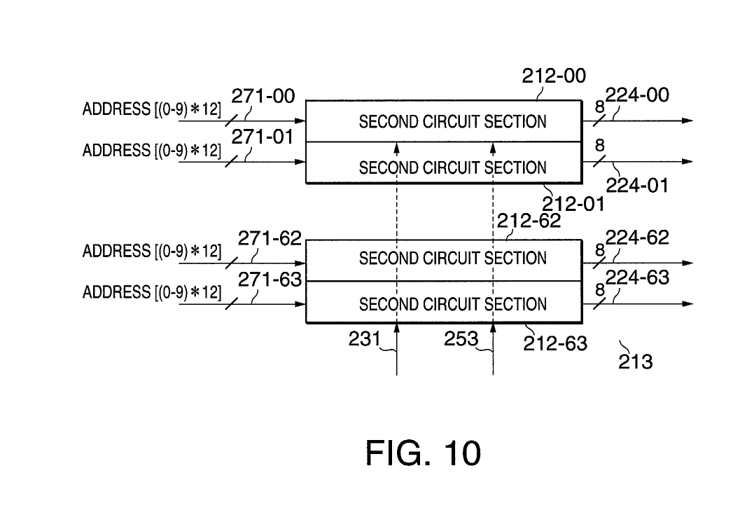

FIG. 9 shows an example of the second circuit section 212 in the matrix switch circuit 206 shown in FIG. 7. The circuit 212 is provided with twelve first circuits 211-00 to 211-11, a 5-bit counter 222 that receives the clock signal 253 of 78 MHz and outputs counter output 221 and a 12-to-1 selector 223 that receives each output 258 from the twelve first circuits 211-00 to 211-11 and selects unit data in order. A frame signal 224 composed of one frame which is STS-12 where 12 pieces of STS-1 are connected is output from the selector 223. The clock signal 253 of 78 MHz is also supplied to twelve first circuits 211-00 to 211-11. Ten-bit address information 261-00 to 261-11 for selecting these circuits are supplied to the twelve first circuits 211-00 to 211-11. The 12-to-1 selector 223 is provided with twelve data input terminals D0 to D11, receives signals 258-00 to 258-11 output from the respective corresponding first circuits 211, also receives the data 221B of low-order four bits of the 5-bit counter 222 from the selective input terminal S and selects the output signals 258-00 to 258-11 by 8 bits in parallel.

10 corresponds to the matrix switch circuit 213 in the example shown in FIG. 7. A circuit 213 is provided with 64 pieces of second circuit sections 212-00 to 212-63 and outputs 64 pieces of frame signals 224-00 to 224-63 one of which is composed of STS-12. Sixty-four second circuits 212 of the circuit 213 respectively receive40-Gbit input data 231, address information 271-00 to 271-63 having the data configuration of 10 bits ×12 and the clock signal 253 of 78 MHz, and respectively output 64 pieces of frame signals 224-00 to 224-63 each of which is 8 bits in parallel. In this output, STS-12 includes 8×64 bits and tip is equivalent to 512 pieces of outputs.

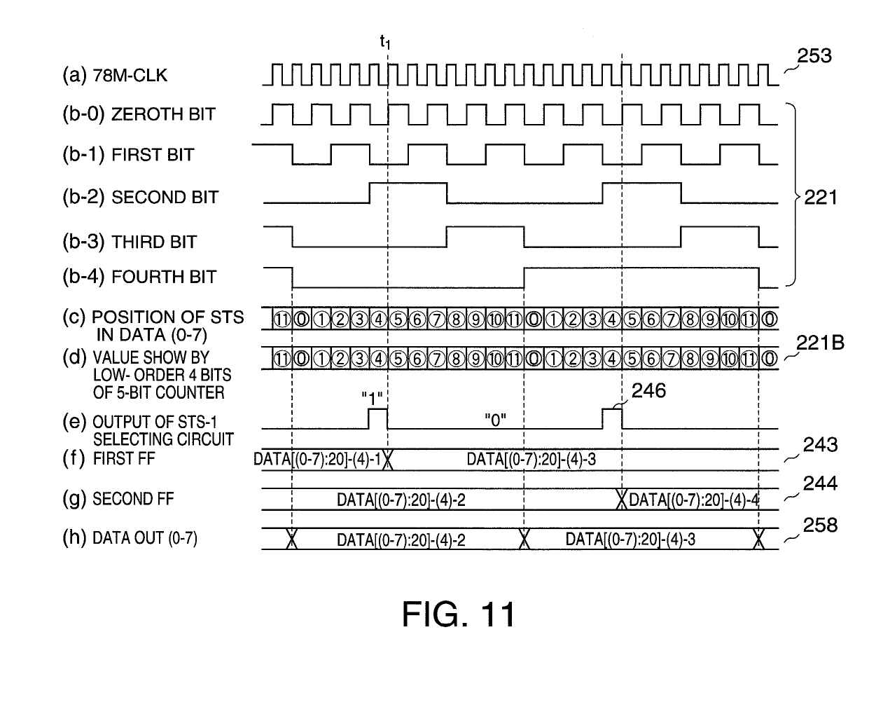

FIG. 11 is a time chart showing the operation of the example of the matrix switch circuit. A chart (a) in FIG. 11 shows the clock signal 253 of 78 MHz. Charts (b-0) to (b-4) in FIG. 11 respectively show the output 221 of the 0 th to 4 th bits of the 5-bit counter 222 that divides the clock signal 253. A chart (c) in FIG. 11 shows the position and the number of unit data (STS-1) in one frame in input data 231. In the chart (c) in FIG. 11, a frame (STS-12) including twelve unit data from unit data (0) to unit data (11) is repeated in synchronization with each leading edge of the clock signal 253 of 78 MHz. A chart (d) in FIG. 11 shows the number of unit data (STS-1) in the data 221B of low-order four bits out of the output 221 of the 5-bit counter 222.

Next, an example that a byte is input to the data latch flip-flop circuit 242 shown in FIG. 8 will be described. For example, it is supposed that the byte is a fourth byte out of twelve unit data (STS-1) in a frame (STS-12) equivalent to twentieth input unit data out of 64 pieces of input unit data of 622 Mbps. In this case, in the selector 233, a sector address in units of 622 Mbps is set to 20 out of 6-bit addresses from 00 to 63 and a sector address in units of unit data (STS-1) is set to 4 out of 4-bit addresses from 00 to 11. At this time, the 64-to-1 selector 233 selects a twentieth signal out of input data 231.

In the meantime, the data 221B of low-order four bits of the output 221 of the 5-bit counter 222 shown in FIG. 9 is supplied to four exclusive OR circuits 249 by one bit in parallel. The exclusive OR circuit 249 compares the data 221B and the information 234B of the low-order four bits showing the position of unit data (STS-1) in a frame (STS-12) by one bit. As a result, when these four bits showing an address and bits showing four count values are all coincident, four bits input to the AND gate 251 all becomes land the signal 246 output from the STS-1 selecting circuit 235 becomes 1. A chart (e) in FIG. 11 shows the output signal 246. When the output signal 246 becomes 1 at time t1, the output of a logical element 247 becomes 1 and the enable terminal E of the first flip-flop circuit 243 is enabled. As a result, a byte equivalent to the twentieth of 64 pieces of input unit data and the fourth in a frame (STS-12) is fetched in the first flip-flop circuit 243 as shown in a chart (f) in FIG. 11. The first flip-flop circuit 243 and the second flip-flop circuit 244 are alternately turned enabled or disabled every 12 clocks, that is, in units of one frame. A chart (g) in FIG. 11 shows the second flip-flop circuit 244 fetches data behind 12 clocks. Writing to the flip-flop circuit the en able terminal of which is masked disabled while the enable terminal is masked. The reading switching selector 257 outputs the output signal 255 or 256 from the flip-flop circuit the enable terminal of which is masked as the output signal 258 as shown in a chart (h) in FIG. 11. Therefore, an output signal of 622 Mbps in which unit data (STS-1) is fetched according to a format of a frame (STS-12) can be acquired by setting the address of the first circuits 211-00 to 211-11 shown in FIG. 9 in order.

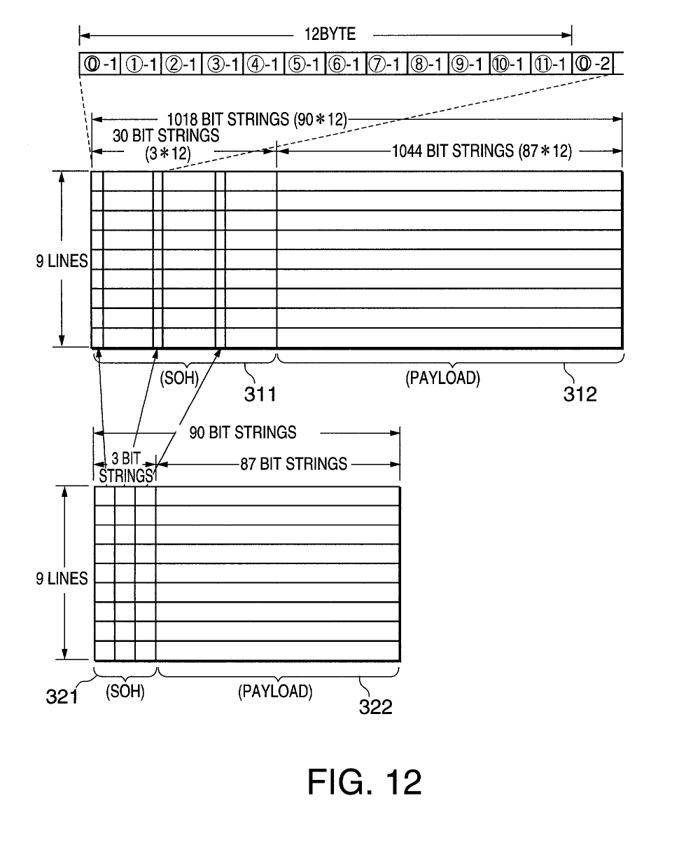

FIG. 12 shows relationship between a format of 622 Mbps (STS-12) and a format of 52 Mbps (STS-1). STS-12 has configuration that 12 types of STS-1 (unit data) are arranged by one byte. “Byte” in FIG. 11 means a first byte in a section over head (SOH) 311 and 321, however, payloads 312 and 322 can be also included.

In the above-mentioned examples, a signal in which 12pieces of STS-1 are multiplexed is used. Therefore, though the matrix switch has the input of 768 and the output of 768, (64×8), that is, 512 signals are input and output. As the matrix switch circuit in this concrete example handles smaller signals than the number of signals in a conventional type, the layout is facilitated. In this concrete example, the 64-to-1 selector 233 selects the same signal of 622 Mbps until address information 234 for selection is changed. In an SDH system, an address is switched in units of frame. One frame is equivalent to 125 μsec. (8 kHz) . However, actually, an address is hardly switched every frame. Therefore, a frequency at which an address is switched is low enough, compared with the frequency of a signal of certain MHz. The large-scale switch in this example is generally realized by CMOS LSI. The power consumption of CMOS LSI increases in proportion to the operating frequency. As an address line is fixed in the matrix switch circuit in this embodiment, a selector the power consumption of which is extremely low can be realized if the configuration of the 64-to-1 selector 233 is devised. As a result, the power consumption of the matrix switch circuit can be greatly reduced.

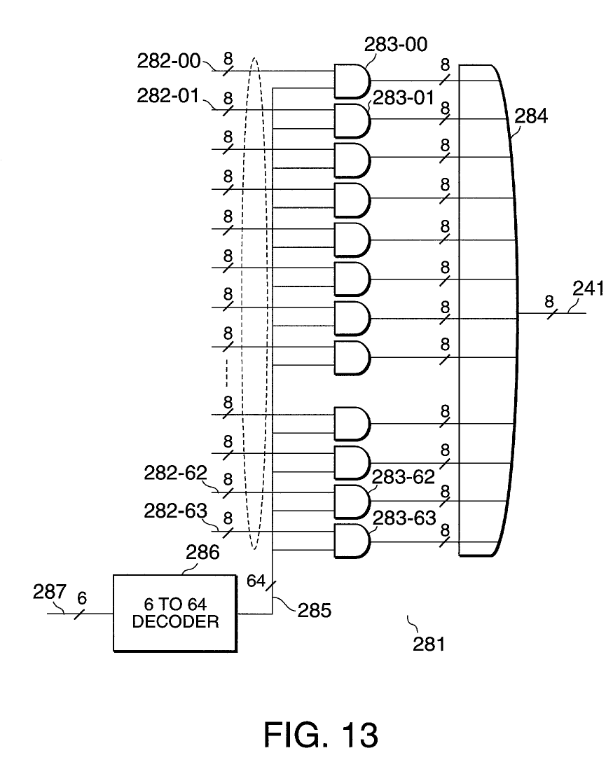

FIG. 13 shows another example of the selector. This selector 281 is provided with 64 sets of 2-input AND gates 283-00 to 283-63 for enabling data and a 64-input OR gate 284 arranged on the output side of the AND gates. Respective eight selector input lines 282 and an output signal conductor 285 from a 6-to-64 decoder 286 are connected to each 2 -input AND gate 283. An 8-bit parallel signal 241 is output from the OR gate 284. The total eight 2-input AND gates 283-00 are arranged, the output signal conductor 285 is connected to the eight gates in common and the selector input line 282-00 is connected to the eight gates. Another 2-input AND gate 283 is also similar. Forty-Gbit input data 231 shown in FIG. 8 is divided into 64 pieces and is input to the 64 sets of selector input lines 282-00 to 282-63 as unit data (STS-1) of 622 Mbps 232-00 to 232-63 by 8 bits in parallel. Six-bit address information 287 is supplied to the 6-to-64 decoder 286. Specific one set of gates out of 64 sets of 2-input AND gates 283 are made to conduct by the 6-bit information. As the residual 63 sets of gates are disconnected, the power consumption of the whole can be greatly reduced.

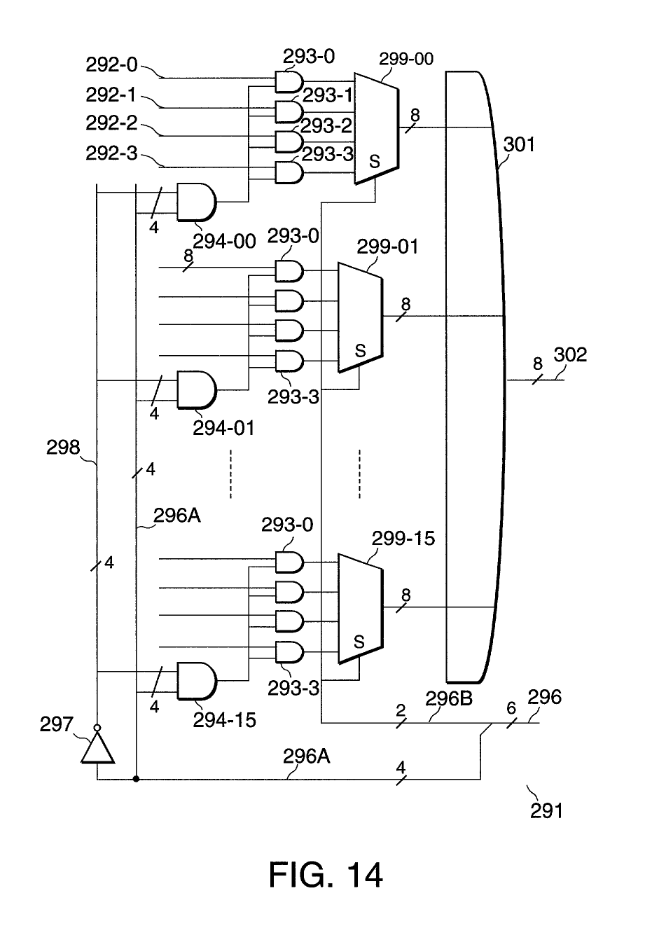

FIG. 14 shows further another example of the selector. A selector 291 is provided with total 16 sets (one set includes 4 pieces) of selector input lines 292-0 to 292-3. These selector input lines 292 are connected to each one input terminal of the respective corresponding 2-input AND gates 293-0 to 293-3. Each output terminal of 4-input AND gates 294-00 to 294-15 is connected to the other input terminal of the 2-input AND gate 293. A signal 296A from a 4-bit address line of a 6-bit parallel address line 296 and a signal 298 acquired by inverting the signal 296A from the 4-bit address line by an inverter 297 are input to the respective input terminals of the 4-input AND gates 294-00 to 294-15. Four signals out of total eight signals of the four signals 296A and the four inverted signals 298 are respectively input to these 4-input AND gates 294-00 to 294-15. Each AND gate 294 outputs a signal when the signal 296A has the following value.

294-00 . . . 296A =“0000”

294-01 . . . 296A =“0001”

294-02 . . . 296A =“0010”. . . . . .

924-13 . . . 296A =“1101”

294-14 . . . 296A =“1110”

294-15 . . . 296A =“1111”

The output terminals of four 2-input AND gates 293-0 to 293-3 are connected to each input terminal of 4-to-1 selectors 299-00 to 299-15 provided by 8 sets per each. Eight sets of 16-input OR gates 301 are arranged on the output side of these 16 sets of 4-to-1 selectors 299-00 to 299-15 and the OR gate 301 outputs an 8-bit parallel selector selection signal 302. output of the residual 2-bit address line 296B of the 6-bit parallel address line 296 is input to each selection input terminal S of the 4-to-1 selectors 299-00 to 299-15 and one of four inputs to the selector 299 is selected. As the selector 291 has a little more gate circuits, compared with those of the selector 281 shown in FIG. 13, the power consumption increases a little.

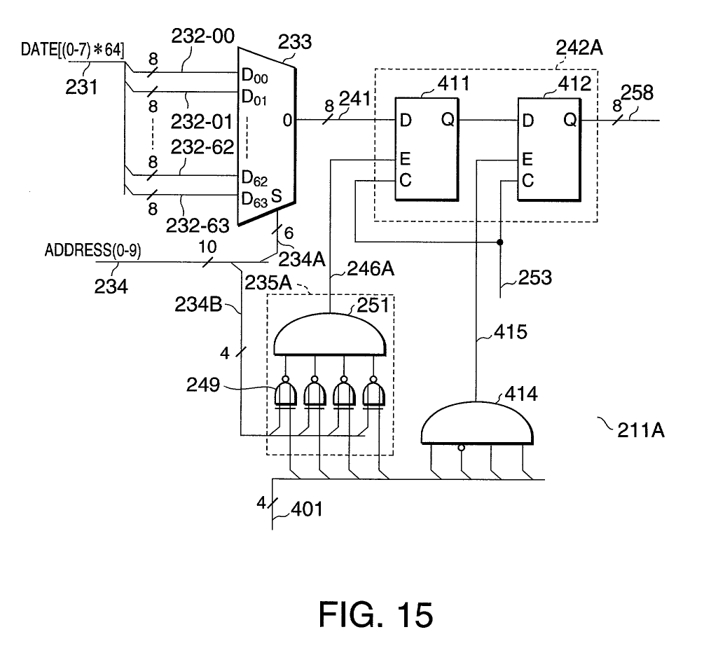

FIG. 15 shows another example related to the first circuit of the matrix switch circuit shown in FIG. 8. A first circuit 211A is provided with a 64-to-1 selector 233 to which unit data (STS-1) 232-00 to 232-63 acquiredbydividing 40-Gbit input data 231 into 64 pieces of 622 Mbps is input by 8 bits in parallel. The information 234A of high-order 6 bits of 10-bit address information 234 is input to a select terminal S of the 64-to-1 selector 233. The information 234B of low-order 4 bits of the 10-bit address information 234 shows the position of unit data (STS-1) in STS-12. The 4-bit information 234B is input to an STS-1 selecting circuit 235A and is input to an exclusive OR circuit 249 together with the output 401 of a 4-bit counter not shown. An 8-bit parallel signal 241 output from an output terminal 0 of the 64-to-1 selector 233 is input to a data latch flip-flop circuit 242A. The data latch flip-flop circuit 242A has configurationthat a first flip-flop circuit 411 and a second flip-flop circuit 412 are cascaded. The output terminal Q of the first flip-flop circuit 411 is connected to the data input terminal D of the second flip-flop circuit 412. A clock signal 253 of 78 MHz is input to each clock input terminal C of these flip-flop circuits 411 and 412. A signal 246A output from an STS-1 selecting circuit 235A is input to an enable terminal E of the first flip-flop circuit 411. The output 415 of a decoder 414 to which the output 401 of a 4-bit counter is input is input to an enable terminal E of the second flip-flop circuit 412. The data latch flip-flop circuit 242A outputs an output signal 258 like the 8-bit output signal 258 shown in FIG. 8.

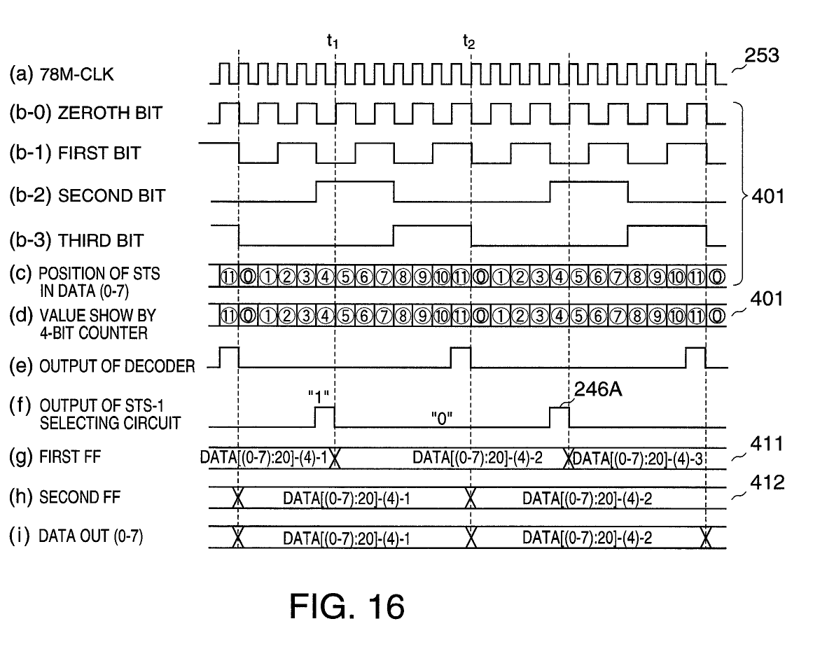

FIG. 16 shows the operation of the first circuit section shown in FIG. 15. A chart (a) in FIG. 16 shows a clock signal 253 of 78 MHz. Charts (b-0) to (b-3) in FIG. 16 respectively show the output 401 of a 0 th bit to a third bit of a 4-bit counter that divides the clock signal 253. A chart (c) in FIG. 16 shows a number of unit data (STS-1) in one frame of the input data 231. Twelve unit data from first unit data (0) to eleventh unit data (11) form each frame (STS-12) in synchronization with each leading edge of the clock signal 253 of 78 MHz. As shown in a chart (d) in FIG. 16, the output 401 of the 4-bit counter shows a number itself of unit data (STS-1).

A case that a predetermined byte is input to the data latch flip-flop circuit 242A in the circuit shown in FIG. 15 will be described below. For example, assume that the byte is equivalent to a twentieth unit data of 64 pieces of input unit data of 622 Mbps and a fourth byte of twelve unit data (STS-1) in a frame (STS-12) . In this case, in the selector 233, a 6-bit address addressable from “00”to “63”as a sector address in units of 622 Mbps is set to 20 and a 4-bit address addressable from “00”to “11”as a sector address in units of unit data (STS-1) is set to 4. At this time, the 64-to-1 selector 233 selects a twentieth signal in the input data 231. In the meantime, the output 401 of the 4-bit counter is supplied to four exclusive OR circuits 249 by one bit in parallel. The exclusive OR circuit 249 compares the output 401 and the information 234B of low-order 4 bits showing theposition ofunit data (STS-1) in a frame (STS-12) by one bit. As a result, when these four bits showing an address and four bits showing a count value are all coincident, four bits input to an AND gate 251 all become 1 and an output signal 246A of an STS-1 selecting circuit 235A becomes 1. A chart (f) in FIG. 16 shows the output signal 246. When the output signal 246A becomes 1 at time tl, an enable terminal E of the first flip-flop circuit 411 is enabled. As a result, a byte which is twentieth out of 64 pieces of input unit data and which is fourth in a frame (STS-12) is fetched in the first flip-flop circuit 411 as shown in a chart (g) in FIG. 11. A value 415 of the decoder 414 supplied to an enable terminal E of the second flip-flop circuit 412 becomes 1 at time t2 different from the time t1 as shown in a chart (e) in FIG. 16. Therefore, a signal output from an output terminal Q of the first flip-flop circuit 411 is fetched in the second flip-flop circuit 412 at the time t2 and is output as the output signal 258 as shown in FIGS. 16H and 16I. Therefore, an output signal of 622 Mbps in which unit data (STS-1) is fetched according to a format in a frame (STS-12) can be acquired by setting addresses of the first circuits 211-00 to 211-11 shown in FIG. 9 in order.

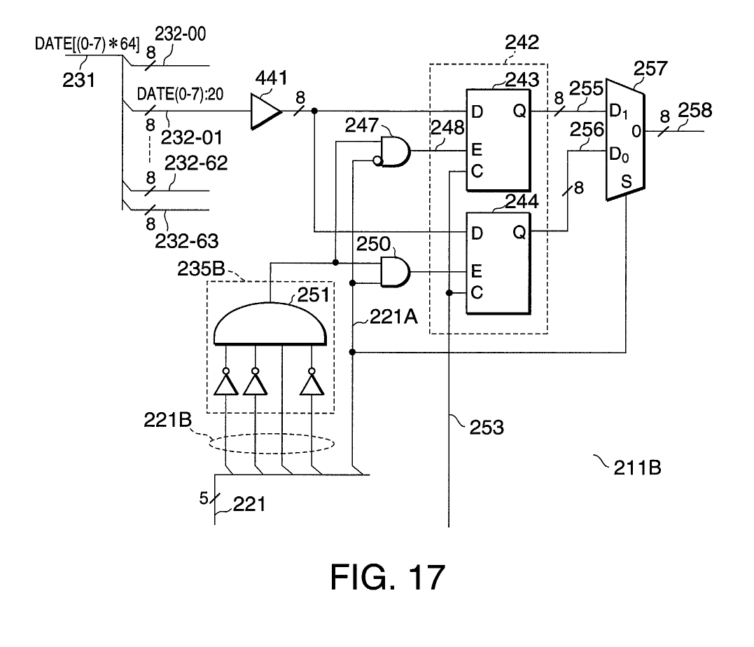

FIG. 17 shows another example of the first circuit section of the matrix switch circuit. A first circuit section 211B is provided with a field programmable gate array (FPGA). In case a 64-to-1 selector 233 and an STS-1 selecting circuit 235B are formed by FPGA, the selector 233 is a buffer 441 and the selecting circuit 235B is also a simple decoder. Therefore, in LSI provided with this FPGA, the scale of the circuit can be greatly reduced. That is, it is also effective that the matrix switch circuit according to the invention is realized by CMOS LSI, however, further, the scale and the power consumption can be greatly reduced by forming the switch circuit by LSI provided with FPGA and FPGA itself. In an SDH system, switching is set in SOH (see FIG. 12) having a fixed value and in case the fixed value is input to a circuit after switching again, it takes relatively long time to switch. Data on a first line, in a first bit string and on the first line and in a second bit string of SOH are respectively defined as A1 and A2 and are fixed values. STS-12 is 24 bytes including Al and A2, that is, is equivalent to 24 clocks of 78 MHz (12.8 nsec. ×24 =307 nsec.). Therefore, it is required to be switched in 307 nsec. or less. FPGA which can be switched in such time can be used.

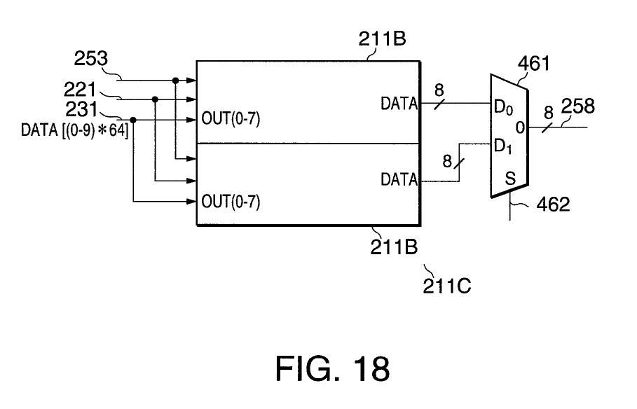

FIG. 18 shows an example of a first circuit section 211C using FPGA which cannot be switched in the above-mentioned switching time. The circuit 211C has two first circuit sections 211B shown in FIG. 17. The output of these two circuits 211B is respectively input to two input terminals D-0 and D-1 of an operation selection selector 461. A selection signal 462 input from a selection signal input terminal S selects an 8-bit output signal 258. While one of the first circuit sections 211B is operated as a switch, FPGA is reloaded in the other circuit 211B. The first circuit section 211C shown in FIG. 18 requires the double number of components such as a data latch flip-flop circuit 242, compared with the number of components of the circuit 211B shown in FIG. 17. However, as a 64-to-1 selector 233 which accounts for most of the scale of the circuit is not required, the scale of the circuit and the power consumption can be greatly reduced.

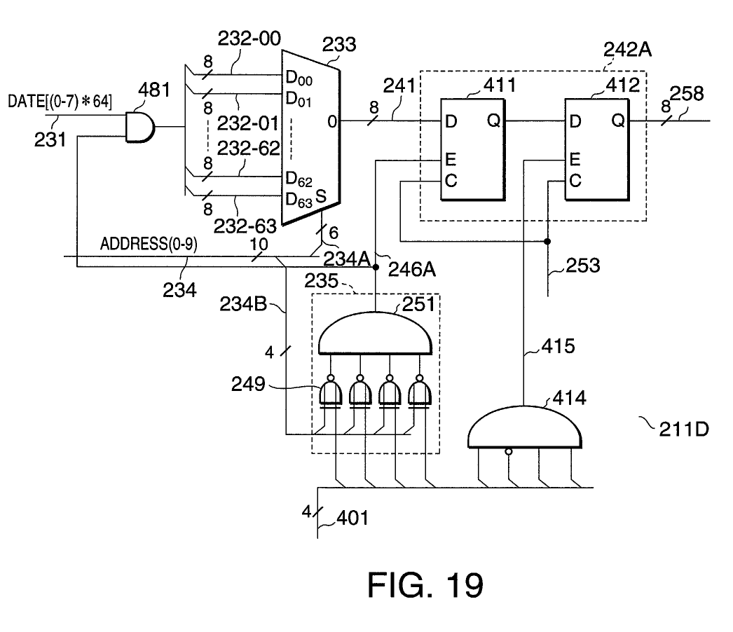

FIG. 19 shows another example of the first circuit section. In a first circuit section 211D, unit data (STS-1) 232-00 to 232-63 acquired by dividing 40-Gbit input data 231 into 64 pieces of 622 Mbps by 8 bits in parallel are input to a 64-to-1 selector 233 via 512 (8×64) pieces of 2-input AND gates 481 in parallel. A signal 246A output from an STS-1 selecting circuit 235 is input to the other terminal of the 2-input AND gate 481. The 2-input AND gate 481 ANDs the input data 231 and the output of the STS-1 selecting circuit 235. Therefore, the 2-input AND gate 481 outputs only unit data (STS-1) of one byte specified in the STS-1 selecting circuit 235 in STS-12 and in other time slots, the output of the 2-input AND gate 481 is fixed to 0. As a result, an input terminal of the 64-to-1 selector 233 is operated only once (however, the number of changing points is twice) of 12 time slots. This means that an input signal rate to the 64-to-1 selector 233 lowers from 78 Mbps to 13 Mbps which is equivalent to ⅙of 78 Mbps. Therefore, an advantage that the power consumption of the 64-to-1 selector 233 is reduced up to ⅙is produced. That is, in this example, the power consumption can be further reduced.

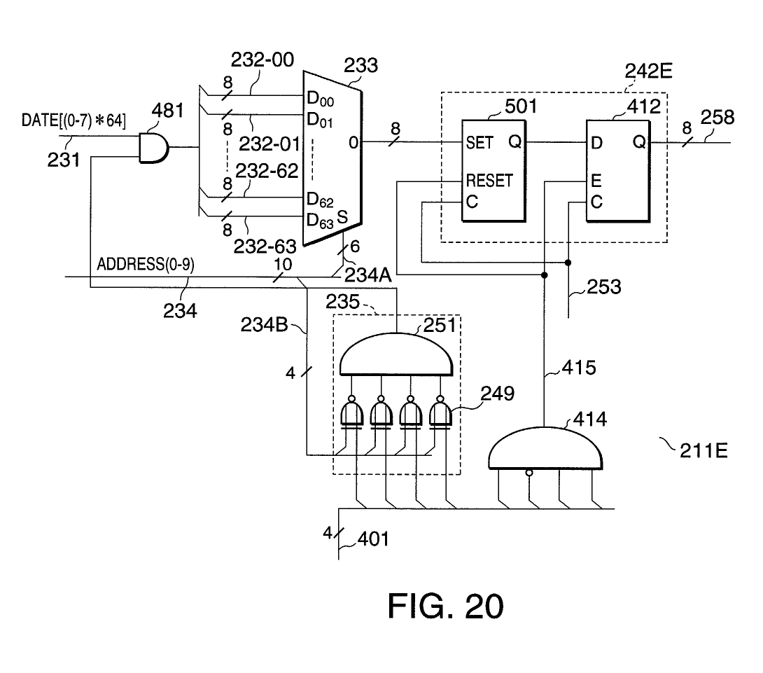

FIG. 20 shows another example of the first circuit section. In a first circuit section 211E, a first flip-flop circuit 501 included in a data latch flip-flop circuit 242E is reset-set flip-flop. A second flip-flop circuit 412 is the same as the flip-flop circuit 412 shown in FIG. 19. In the first flip-flop circuit 501, the output of a 64-to-1 selector 233 is input to a set terminal “Set” and a value 415 output from a decoder 414 is input to a reset terminal “Reset”. A clock signal 253 of 78 Mbps is input to a clock input terminal C. In the reset-set flip-flop circuit, in case a set and a reset are simultaneously turned on, a set is preceded. As bytes except bytes selected in a 2-input AND gate 481 and the 64-to-1 selector 233 are all 0, the reset-set flip-flop circuit used for the first flip-flop circuit 501 as described above can be operated. When an asynchronous type is adopted as the first flip-flop circuit 501, the circuit scale and the power consumption can be further reduced. As described above, in this example, the arrangement of the 64-to-1 selector 233 and the STS-1 selecting circuit 235 can be exchanged.

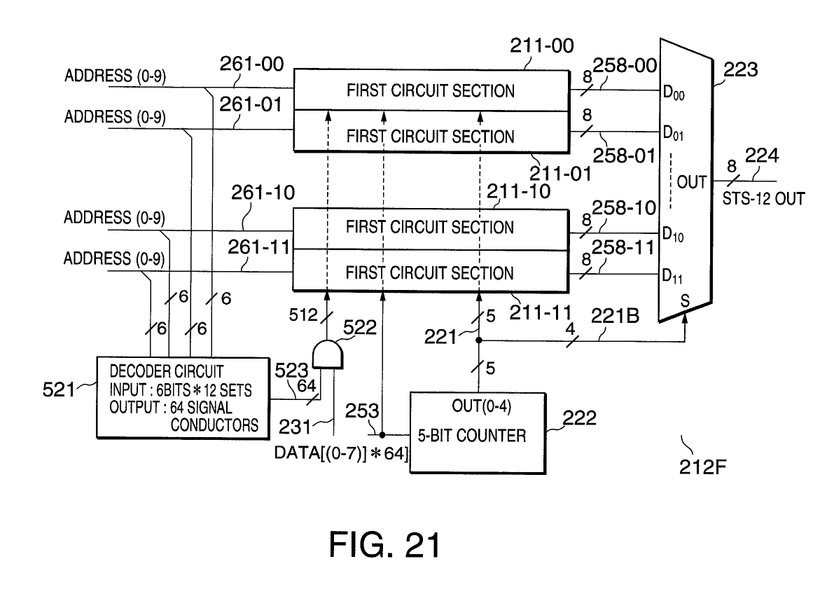

FIG. 21 shows an example of the second circuit section in the matrix switch circuit. A second circuit section 212F is further provided with a decoder circuit 521 and an AND gate 522, compared with the circuit shown in FIG. 9. The second circuit section 212F is provided with twelve first circuit sections 211-00 to 211-11 and each first circuit section selects one type of STS-12 out of 64 types, that is, a signal for one frame. Therefore, these twelve first circuit sections 211-00 to 211-11 select maximum 12 types of STS-12 out of 64 types. Some of the twelve first circuits 211-00 to 211-11 may select the same STS-12 and in this case, STS-12 of types smaller than 12 types are selected. Each 6-bit address information of 10-bit address information 261-00 to 261-11 is input to the decoder circuit 521. The decoder circuit 521 decodes respective address values, ORs them and identifies selected STS-12 out of 64 types. As a result of the identification, the decoder circuit 521 outputs 1 for selected STS-12 out of 64 identification signal output lines 523 and outputs 0 for unselected STS-12. These 64 identification signal output lines 523 are connected to each one input terminal of the 512 (8×64) pieces of 2-input AND gates 522 by 8 pieces in common. Unit data acquired by dividing 40-Gbit input data 231 into 64 pieces of 622 Mbps by 8 bits in parallel is input to the other input terminal of these 512 (8 ×64) pieces of 2-input AND gates 522. Hereby, unselected STS-12 can be fixed to 0. That is, as 12 sets out of 64 sets are operated, actuating signals can be reduced up to 12/64(approximately ⅕) The power consumption of the selector in the first circuits 211-00 to 211-11 is reduced by fixing unselected STS-12 to 0 as described above.

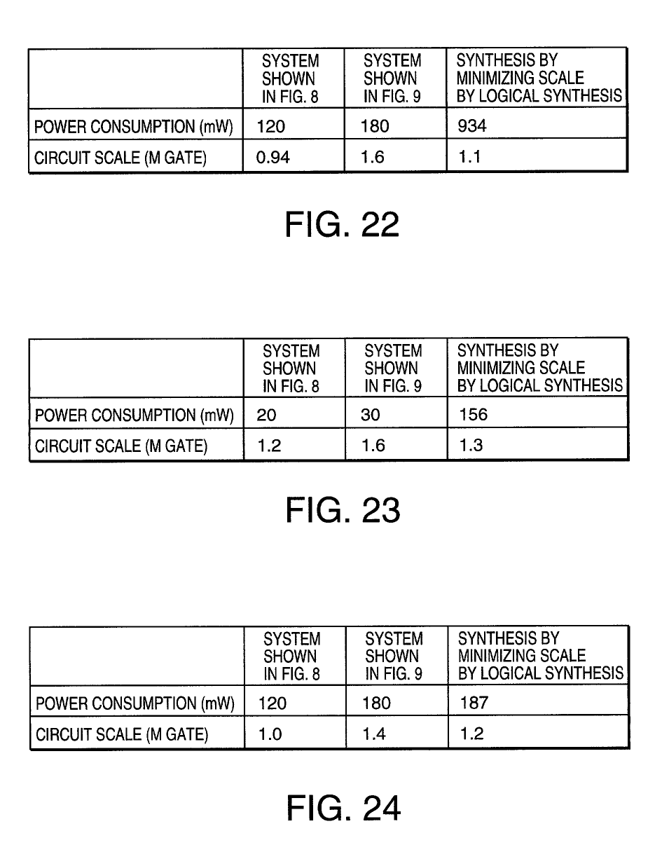

FIGS. 22, 23 and 24 respectively show values of the circuit scale and the power consumption of a selector having the configuration shown in FIG. 13, having the configuration shown in FIG. 14 and having the configuration in which the scale is minimized by logical synthesis by a well-known CAD tool. A case that a MOS transistor has the gate length of 0.25 μm will be described below. FIG. 22 uses the first circuit section shown in FIG. 8, FIG. 23 uses the first circuit section shown in FIG. 19 and FIG. 24 uses the second circuit section shown in FIG. 21. M gate in these drawings means a megagate.

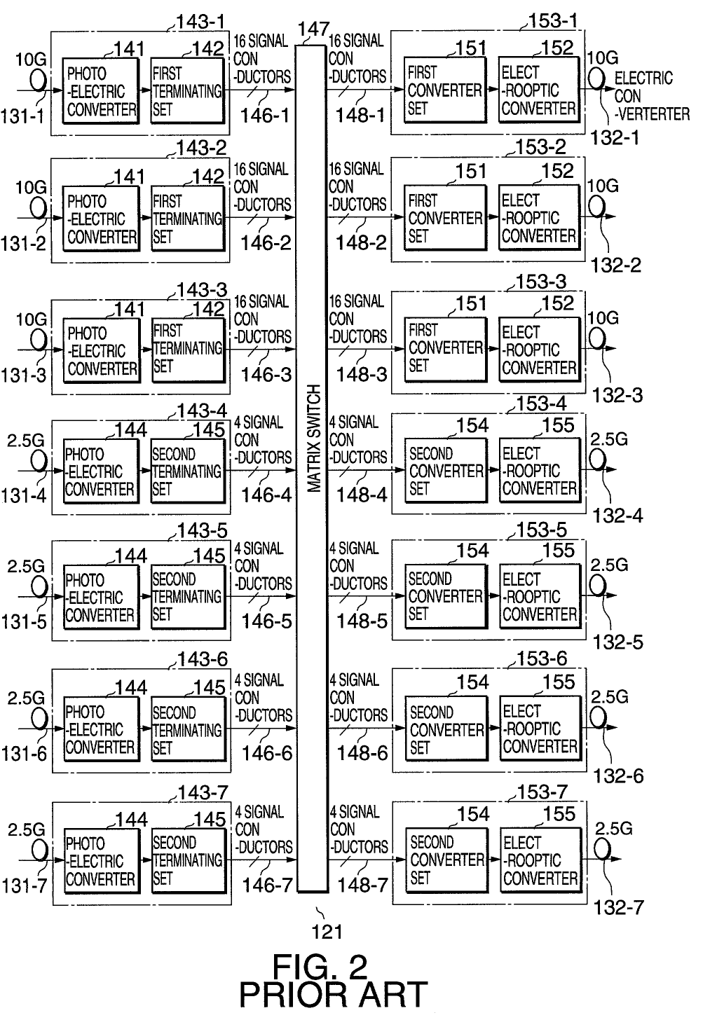

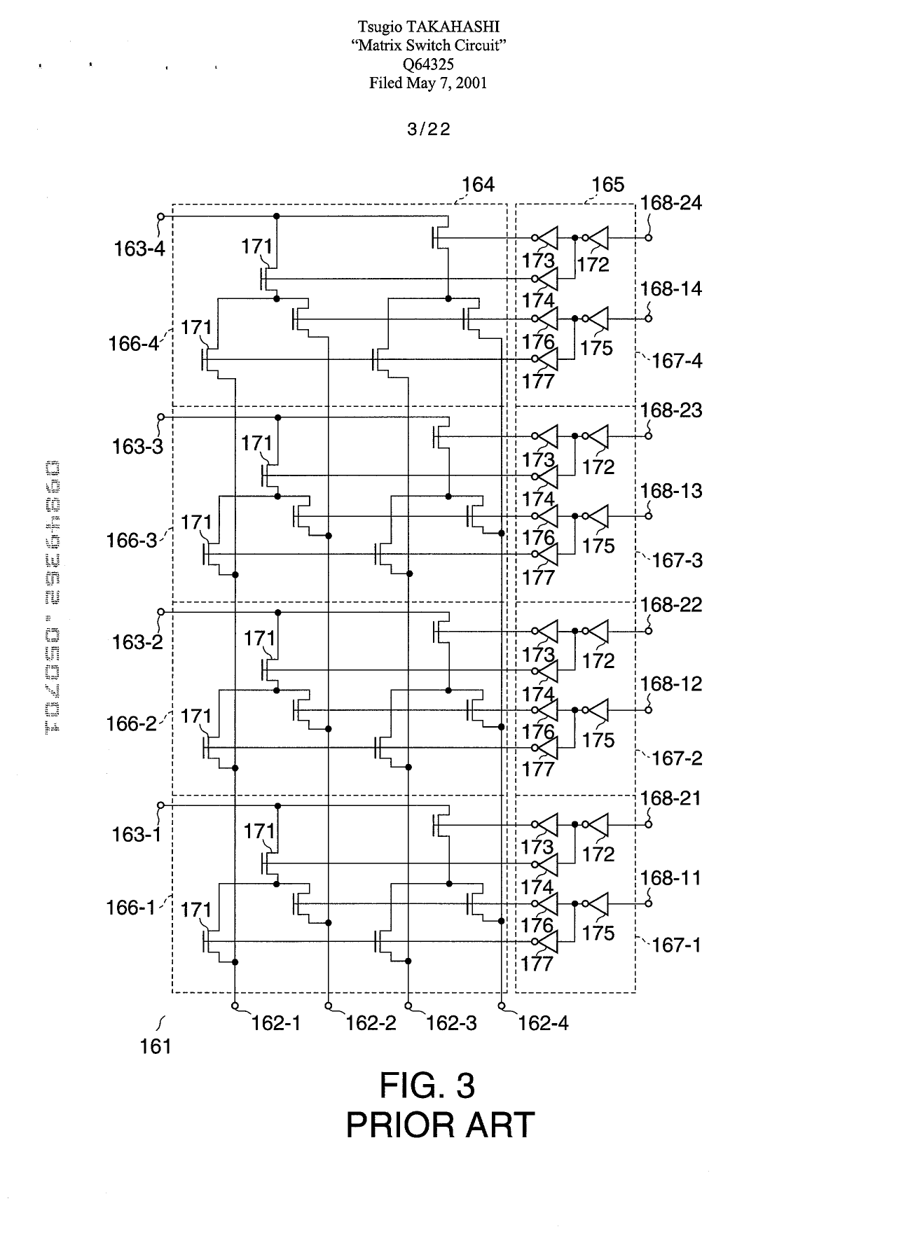

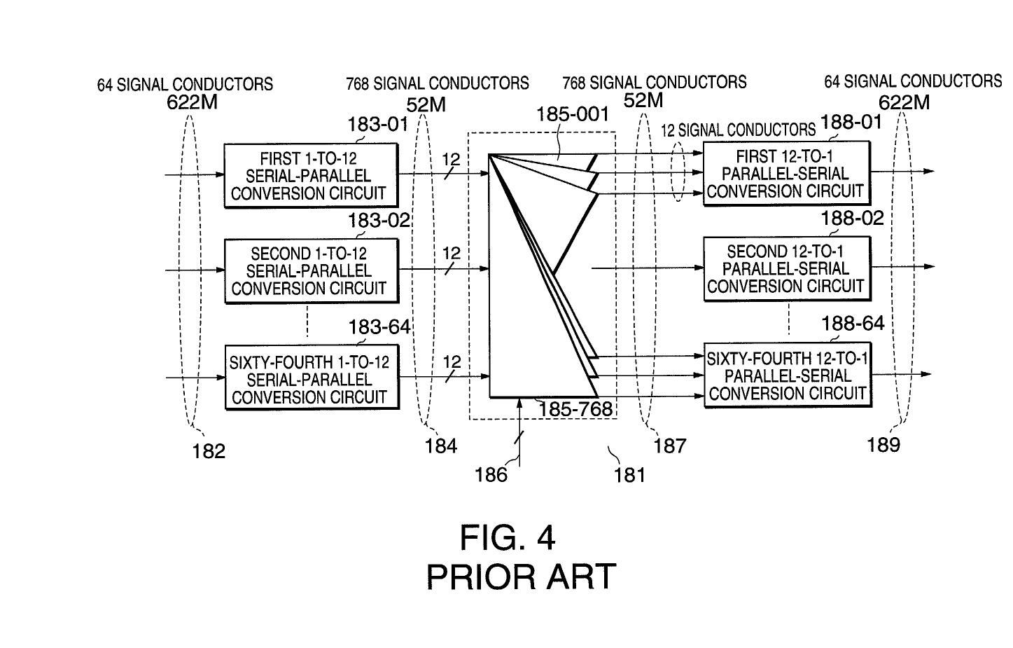

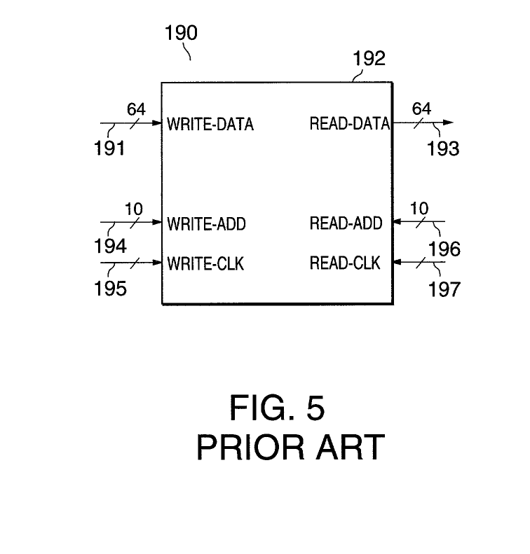

In the above-described concrete examples, a signal of 622 Mbps is an 8-bit parallel signal. However, a signal of 622 Mbps maybe also 8-bit serial data. In this case, one 64-to-1 selector 233 has only to be provided, compared with the circuit shown in FIG. 8. However, the same number of data latch flip-flop circuits 242 as the number in the case of parallel signals are required to hold 8-bit data. Most of the scale of the circuit accounts for the 64-to-1 selector 233 shown in FIG. 2. Therefore, in case this circuit is realized by a CMOS integrated circuit, the scale of the circuit is reduced up to approximately 1/8 owing to the reduction of the 64-to-1 selectors 233. However, as a clock signal of 622 MHz is used in place of a clock signal 253 of 78 MHz, the operating frequency of the circuit is increased up to 8 times. Therefore, the power consumption of the circuit has substantially the same value as that of the circuit shown in FIG. 8.

In case the matrix switch circuit is integrated by CMOS LSI as described above, the power consumption is substantially fixed independent of the number of parallel signals. Therefore, to determine whether serial processing or parallel processing is to be performed in case a circuit is actually integrated, the following points are to be considered.

(A) Facility of a layout (the scale of a circuit)

(B) Facility of timing design (clock speed)

(C) Performance of a used device

Parallel processing is not required to be limited to 8 bit parallel in which a clock frequency is 78 MHz, and 2 bit parallel in which a clock frequency is approximately 311 MHz, 4 bit parallel in which a clock frequency is approximately 155 MHz and 16 bit parallel in which a clock frequency is approximately 39 MHz can be suitably selected.

In the above-mentioned examples, the data latch flip-flop circuit 242 is provided with the first flip-flop circuit 243 and the second flip-flop circuit 244. However, the circuit 242 may be also formed by a memory or a latch. In this case, an optimum type is also required to be selected in consideration of the layout and the power consumption. In case the operation of the data latch flip-flop circuit 242 is asynchronous, the power consumption of a clock line can be reduced and as a result, the power consumption of the whole circuit is reduced.

Also, in the example, the case that the 64-to-1 selector selects any of 64 inputs grouped into twelve and forms the matrix switch circuit is described. To express this by a matrix of 12 ×64, the invention can be applied to a matrix switch circuit of n x m (n, m: two or larger arbitrary integer) in arbitrary size. A desired clock frequency can be also selected. Further, in FIG. 14, no inverter 297 may be also used, only the signal 296A from the 4-bit address line may be also input and a 4-input AND circuit according to a negative logic input format may be also used.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. A matrix switch circuit, comprising:
total (n×m) pieces of m-to-1 selectors to which one frame where n (n: positive integer) pieces of unit data are serially arrayed is input by m (m: positive integer) pieces in parallel, from which predetermined one frame specified in an address is output and which are divided into m pieces of groups each of which includes n pieces;
(n×m) pieces of selecting circuits that respectively receive the output of the m-to-1 selector and respectively select specific unit data specified in an address in one frame;
m pieces of n-to-1 selectors that respectively receive data output from n pieces of selecting circuits, respectively forms and outputs one frame; and
a control circuit that sends a control signal to the selecting circuits and the n-to-1 selectors.

2. A matrix switch circuit, comprising:
total (n×m) pieces of m-to-1 selectors to which one frame where n (n: positive integer) pieces of unit data are serially arrayed is input by m (m: positive integer) pieces in parallel, from which predetermined one frame specified in an address is output and which are divided into m pieces of groups each of which includes n pieces;
(n×m) pieces of selecting circuits that respectively receive the output of the m-to-1 selector and respectively selects specific unit data specified in an address in one frame;
m pieces of n-to-1 selectors that respectively receive data output from n pieces of selecting circuits, respectively forms and outputs one frame; and
a control circuit that sends a control signal to the selecting circuits and the n-to-1 selectors, wherein:
data input to the matrix switch circuit is p (p: positive integer)-bit parallel data; and
(p×n×m) pieces of m-to-1 selectors are arranged, (p ×m) pieces of n-to-1 selectors are arranged and (p×m) pieces of input/output lines are arranged.

3. A matrix switch circuit according to claim 1, wherein:
data input to the matrix switch circuit is p (p: positive integer)-bit serial data.

4. A matrix switch circuit according to claim 1, wherein:
the selecting circuit is provided with first and second circuits to which data output from the m-to-1 selector is written and from which the written data is read and a switching circuit that switches these circuits.

5. A matrix switch circuit according to claim 4, wherein:
the first and second circuits are a flip-flop circuit.

6. A matrix switch circuit according to claim 4, wherein:
the first and second circuits are arranged in parallel with the m-to-1 selector.

7. A matrix switch circuit according to claim 4, wherein:
the first and second circuits are cascaded for the m-to-1 selector.

8. A matrix switch circuit according to claim 7, wherein:
the first circuit on the side of the m-to-1 selector is a reset-set flip-flop circuit.

9. A matrix switch circuit according to claim 1, wherein:
the unit data is a synchronous transfer signal (STS)-1.

10. A matrix switch circuit according to claim 2, wherein:
the unit data is a synchronous transfer signal (STS)-1.

11. A matrix switch circuit according to claim 1, wherein:
the m-to-1 selector comprises:
m pieces of 2-input AND gates;
one m-input OR gate connected to the m pieces of 2-input AND gates; and
a decoder to which address information is input, wherein:
a data input line and an output line of the decoder are connected to each 2-input AND gate; and
the m-input OR gate outputs the output of predetermined one 2-input AND gate.

12. A matrix switch circuit according to claim 11, wherein:
data input to the m-to-1 selector is p (p: positive integer)-bit parallel data;
(p×m) pieces of 2-input AND gates are arranged; and
p pieces of m-input OR gates are arranged.

13. A matrix switch circuit according to claim 1, wherein:
the m-to-1 selector comprises:
m pieces of 2-input AND gates;
q (q<m) pieces of AND gates;
q pieces of selectors; and
a q-input OR gate, wherein:
the m pieces of 2-input AND gates are divided into q pieces of groups;
a data input line and an output line of the AND gate are connected to each 2-input AND gate;
the output of the 2-input AND gate in each group is input to one selector;
the output of q pieces of selectors is input to the OR gate; and
address information is input to the q pieces of AND gates and the q pieces of selectors.

14. A matrix switch circuit according to claim 13, wherein:
data input/output to/from the m-to-1 selector is p (p: positive integer)-bit parallel data;
(p×m) pieces of 2-input AND gates are arranged;
(p×q) pieces of AND gates are arranged:
(p×q) pieces of selectors are arranged; and
pieces of q-input OR gates are arranged.

15. A matrix switch circuit according to claim 1, wherein:
at least one m-to-1 selector is formed by a field programmable gate array.

16. A matrix switch circuit according to claim 2, wherein:
at least one m-to-1 selector is formed by a field programmable gate array.

17. A matrix switch circuit according to claim 1, comprising:
a 2-input AND gate that sends a signal to each rn-to-1 selector, wherein:
unit data is input to one input terminal of the 2-input AND gate and a signal output from the selecting circuit is input the other terminal.

18. A matrix switch circuit according to claim 1, comprising:
a 2-input AND gate that sends a signal to each m-to-1 selector, wherein:
unit data is input to one input terminal of the 2-input AND gate and the output of a decoder circuit that decodes and outputs address information is input to the other terminal.
